(19) United States
(12) Patent Application Publication
(10) Pub. No.: US 2011/0010397 A1
(43) Pub. Date: Jan. 13, 2011

(54) MANAGING ANNOTATIONS DECOUPLED FROM LOCAL OR REMOTE SOURCES

(76) Inventor: Prateek Kathpal, San Jose, CA (US)

Correspondence Address: Law Office of Dorian Cartwright, P.O. Box 7617, San Jose, CA, 95150, US

(21) Appl. No.: 12/623,382

(22) Filed: Nov. 21, 2009

Related U.S. Application Data
(60) Provisional application No. 61/225,108, filed on Jul. 13, 2009.

(51) Int. Cl. G06F 17/00; G06F 15/16; G06F 17/30; G06F 17/24

(52) U.S. Cl. 707/802; 715/230; 709/219; 709/246; 715/249; 707/E17.044

(57) ABSTRACT

Annotation of a local or remote file includes receiving a file. An annotation file that is associated with the file, but stored independently, is retrieved and combined with the file. A viewer, such as a web browser or a proprietary application, displays the remote file with annotations. The processing to render the display can be performed locally at a client, or remotely on a server.

### CROSS-REFERENCE TO RELATED APPLICATIONS

This patent application claims priority under 35 U.S.C. 119(e) to U.S. Provisional Application No. ______ filed Jul. 13, 2009 by Prateek Kathpal, the entire contents of which are herein incorporated by reference.

### FIELD OF THE INVENTION

The present invention relates generally, to electronic annotations, and more specifically, to managing annotations decoupled from local or remote resources.

### BACKGROUND OF THE INVENTION

Currently, electronic documents can be edited by making changes to a display of the document. The changes can be, for example, additional or deleted text, or highlighting of existing text, among others. The changes are saved together with an original file, into an updated file.

Edits to an electronic image or video file can be processed as a separate layer which overlays the image. When the changes are saved, the layer is saved on the same location as the original image and a relationship is created between original file and annotations layer file.

Common to each of these editing techniques, is that annotations are stored along with the file or merged into the file itself. For files accessed and controlled by a single user, this may not pose a problem.

However, online files do pose a challenge for the state of the art techniques. Primarily, the files are typically stored at a remote location that may not be in control by a user making changes or remote files cannot be updated or changed. Furthermore, files can be stored in many different formats, so even if, for example, a document is downloaded by a user to a client, the client may not have a local application for making edits to the document. This is especially true for a thin client, such as a mobile phone application.

Therefore, there is a need for a new technique for annotating files decoupled from a resource.

### SUMMARY OF THE INVENTION

The present invention provides methods, systems, and computer products that meet the above needs. In one embodiment, a method for annotating a local or remote file includes receiving a remote or opening a local file. An annotation file that is associated with the file, but stored independently is retrieved and combined with the file. A viewer, such as a web browser based remote viewer or a local viewer or a proprietary application, displays the file with annotations. The processing to render the display can be performed locally at a client, or remotely on a server.

In one embodiment, a file is displayed first in an original state as stored. An annotation file with annotation data is selected for display. The display can include the file with overlaid annotation data. In another embodiment, a user annotates the file and stores the changes as an annotation file.

In another embodiment, the file is converted from a native format to a common format for display. The common format can allow annotation data to be overlaid in a uniform manner regardless of the native format.

In another embodiment, a local file is opened in a viewer and a search is performed on the remote server or the Internet to get annotations related to the file and allows the user the ability to choose and display all or multiple annotations on the file. The annotations can be from experts, a social network, or other Internet contributors.

Advantageously, the techniques disclosed herein provide annotations to remote or local documents without local storage of a file or annotations, or control of a file by a user. Furthermore, the techniques are implementable in thin clients without additional software.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is a block diagram illustrating a system to annotate remote sources, according to one embodiment of the present invention.

FIG. 2 is a block diagram illustrating a client of the system in FIG. 1, according to one embodiment of the present invention.

FIG. 3 is a block diagram illustrating an annotation server of the system in FIG. 1, according to one embodiment of the present invention.

FIG. 4A is a flow chart illustrating a method for annotating remote resources with local rendering, according to one embodiment of the present invention.

FIG. 4B is a flow chart illustrating a method for annotating a local resource with local rendering, according to one embodiment of the present invention.

FIG. 5 is a flow chart illustrating a method for annotating remote resources with remote rendering, according to one embodiment of the present invention.

FIG. 6 is a schematic diagram illustrating screen shots of an annotation viewer, according to one embodiment of the present invention.

### DETAILED DESCRIPTION OF THE INVENTION

Techniques for annotating local and remote resources are disclosed. In general, a user selects a file (local or remote) for viewing, and then accesses annotations stored separately from the resources.

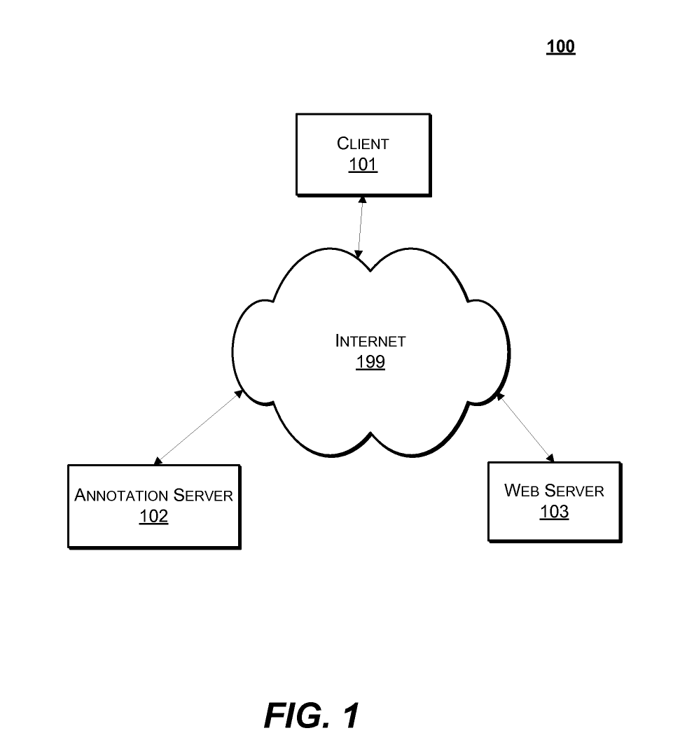

FIG. 1 is a block diagram illustrating a system 100 to annotate remote resources, according to one embodiment of the present invention. The system 100 includes a client 101, an annotation server 102, and a web server 103. Components of the system 100 can be coupled in communication through the Internet 199 as shown in FIG. 1, or alternatively by a local access network, a wide area network, a telephone network, an ATM network, or the like, using any appropriate protocol such as TCP/IP. For example, the annotation server 102 can be locally connected to the web server 104 through a high-speed proprietary network. In general, the system 100 retrieves remote or local sources (e.g., HTML files) and separately retrieves annotation files (e.g., XML files) associated with the resources, and combines the information to display mark-ups to a user.

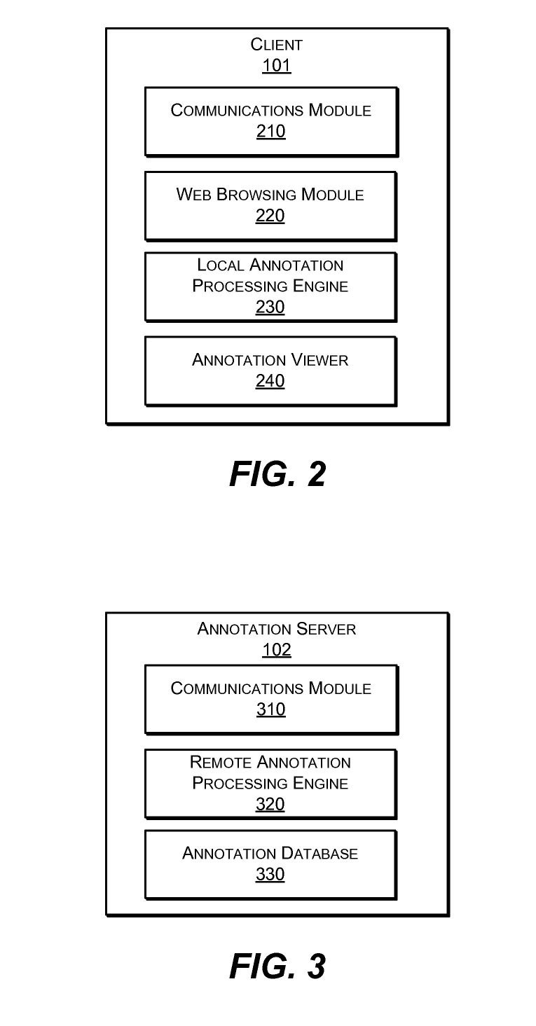

The client 101 can be any device capable of connecting over a network such as a personal computer or mobile device (e.g., cell phone or PDA). As shown in FIG. 2, one embodiment of the client 101 includes a communications module 210, a web browsing module 220, an annotation viewer 230, and a local annotation processing engine 240. Each of these components can be implemented in hardware, software, or a combination of both. Additional components can include an operating system (e.g., Windows, Linux, or a mobile OS), a processor (e.g., a general processing unit, an ASIC, or an FPGA), a hard drive or other memory to store local resources for annotation, a display, and the like. In one embodiment, the client 101 allows a user to view annotations of a remote or local resource, in addition to further annotating the remote resource.

The communications module 210 handles information exchanges with outside resources. More specifically, the communications module 210 can request a web page from the web server 130 and annotation data from the annotation server 102. In one embodiment, the communications module 210 authenticates a user of a device with the annotation server 102.

The web browsing module 220 can be a network browser such as Internet Explorer, Mozilla Firefox, Google Chrome, or other application for accessing resources on a network such as the Internet 199. A software patch or browser plug-in provides compatibility with the other components of the system 100. In another embodiment, the web browsing module 220 is a proprietary software module.

The local annotation processing engine 230 processes the remote file and annotation data. For example, the local annotation processing engine 230 can convert the remote file from a first native format to a common native format. The common native format can be a PDF format or another proprietary format compatible with the annotation data. The local annotation processing engine 230 overlays the annotation data associated with the remote file over the remote file display. Additionally, the local annotation processing engine 230 receives annotations from a graphical user interface for translation to annotation data which is stored separately from the remote file. In another embodiment, some or all of the processing can occur on the annotation server 102, as described below.

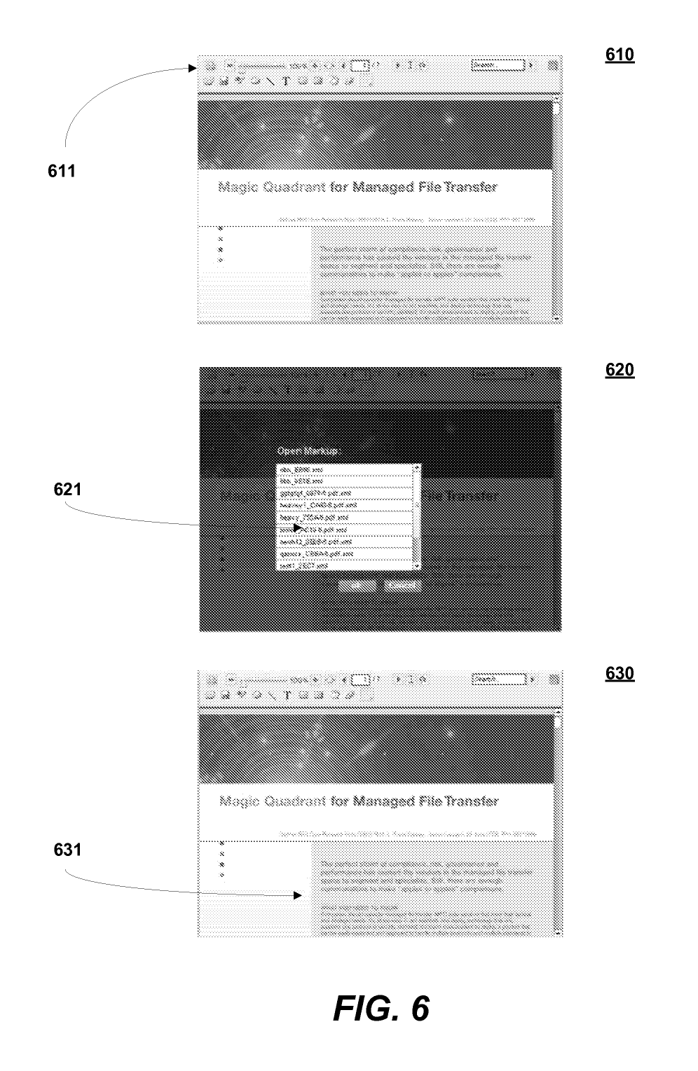

The annotation viewer 240 displays the remote file along with annotations in a GUI, such as the GUI of FIG. 6. The GUI also allows a user to create annotations.

The local or remote resource (e.g., file) can be any text or image source that is viewable locally or over a network. The file can comprise, for example, a web page in HTML or XML format, a document generated by a word processor or spreadsheet and stored in a DOC, XLS, or PDF format, a database table in an RTF format, an image in JPG or GIF format, a video in Flash, WMV or MPG4 format, or the like. In one example, a user opens a locally stored IRS document, and obtains annotations over the Internet from experts or other users or a social network. In another example, a user opens any form on the Internet and receives instructions left as annotations by other users. In yet another example, a user opens a document and advertisements as annotations or markups show up on the document.

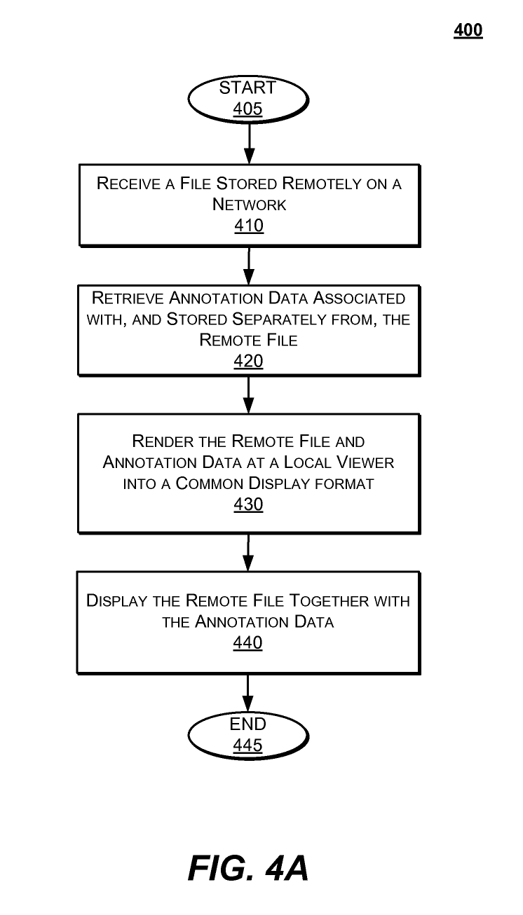

Referring again to FIG. 1, the annotation server 102 can be a personal computer or server blade with a software module. As shown in the embodiment of FIG. 3, the annotation server 102 includes a communications module 310, a remote annotation processing engine 320, and an annotation database 330.

In general, the annotation server 102 provides annotation data for the remote file. The annotation data represents annotations or changes to a remote file in a format such a XML, a proprietary format, or the like. An annotation includes any type of visual mark-ups, changes or edits to a remote file, such as highlights, comments, inserted text, deleted text, altered text, formatted paragraphs or text, inserted or deleted objects, and the like. The annotations can be tied to a specific location in a remote file display such as a particular selection of text in a document file or a specific group of frames in a movie file. In one embodiment, the specific locations of changes are saved in XML source code using headers. The annotations can be separated by user or entity and saved as separate annotation data files. One of ordinary skill in the art will recognize that the examples listed here are merely exemplary and are not exhaustive of the types of annotations implementable by the system 100.

The communications module 310 cooperates with the communications module 210 of the client 110 and with other clients. As such, the communications module 310 can register and authenticate clients that access annotation data.

The remote annotation processing engine 320 provides server-side processing for thin clients. For example, the remote annotation processing engine 320 can perform the functions of the local annotation processing engine 230 of the client 101 by requesting the remote file and overlaying the annotation data. The data can then be combined prior to sending to the client 101 for local display. In one embodiment, the client 101 presents the combined data using a web browser with, for example, JavaScript or Flash technology without additional software.

Turning again to FIG. 1, the web server 103 can be a network server that stores remote files. The remote files can be the same sent to the client 101 using typical web protocols such as TCP/IP or FTP. In one example, the remote files are displayed in the annotation viewer 240 in the same manner as a local file. In another embodiment, the remote files are displayed in a web browser.

In one embodiment, a user making edits at the client 101 and/or an entity maintaining the annotation server 102, has no control over files stored on the web server 103 which may be under control of a different entity. For example, the file can be a tax form available on the IRS web site, while an independent company provides annotations from tax professionals that mark-up the document with instructions about how to fill out the tax form. Another example can be a whitepaper on a company website opened by user in the viewer and all comments from different users regarding the document can come from different locations.

The components of the system 100 can be implemented in hardware, software, or a combination of both. The software components can be source code stored on a computer readable medium such as a disc or hard drive, and executable by a processor. The software can be preinstalled or downloaded over the Internet 199.

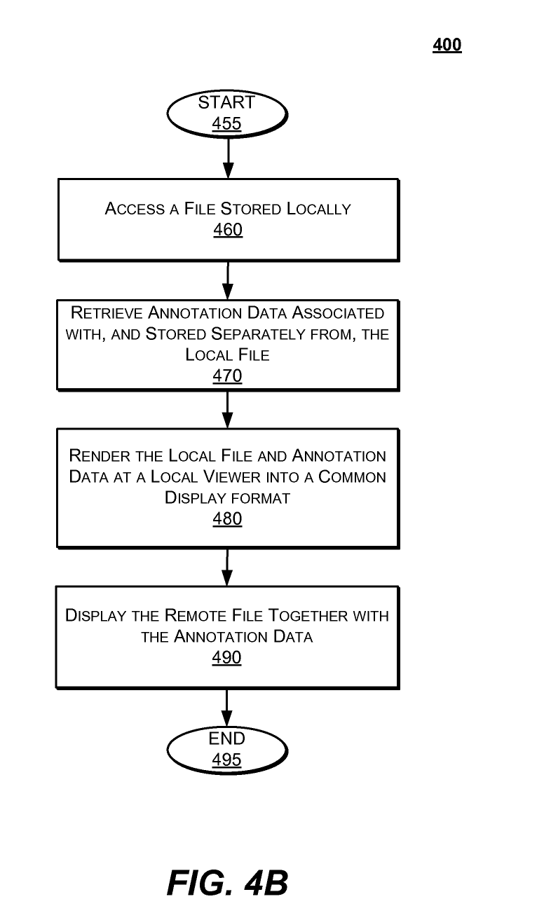

FIG. 4A is a block diagram illustrating a method 400 for annotating remote resources with local rendering, according to one embodiment of the present invention. In one embodiment, the method 400 can be implemented by the various embodiments of the system 100 of FIG. 1.

A remote file is received 410 (from, e.g. the web server 103). The remote file can be requested over a network using a URL or other type of identification by a user. In response, the remote file sent back to a client. In one embodiment, the request and receipt of the remote file occurs in the same manner as if no annotation data exists.

Annotation data associated with the remote file is retrieved 420. Once the request is detected, annotation data can be requested (from e.g., the annotation server 102). The request can be sent before or after the remote file has actually been received. To do so, the URL or other identifier is sent to a specified address for annotation data. A database (e.g., the annotation database 330) is searched, and if there is a match, the annotation data is sent back. In another embodiment, annotation data can be downloaded from a web page, a peer-to-peer sharing service, or the like.

The annotation data can be independently controlled by one entity, while the remote files are controlled by many entities. Thus, the provision of annotation data by an entity does not require cooperation by the other entities. In another embodiment, the annotation data and the remote files can be controlled by a single entity. For example, a social networking web site such as Facebook can provide file annotation among connected users. In this example, a ladies organization can circulate a meeting agenda to registered members, by way of a social networking group, for mark-up and comments. The social networking site can embed or associate a marker with the file to indicate that annotation data exists. In the alternative, a file identifier can be used to check for associated annotation data.

The remote file is rendered 430 (e.g., by local annotation processing engine 230). In one embodiment, rendering includes first converting the remote file from a native format to a common format such as PDF, XML, HTML, a proprietary format, or the like. The native format can be one of many, each of which is converted to the same common format. The common format can be optimized for combining with annotation data, and for receiving new annotations from a user. Combining can include overlaying annotations, inserting objects, adding or deleting text to the remote file as displayed, and the like. Combining annotations in a video file can include adding or deleting frames, or making other video editing changes.

The remote file is displayed 440 together with the annotation data. The combined display is presented in, for example the web browsing module 220, or a proprietary viewer. In one implementation, the remote file is first displayed without any annotation data, as shown in a display 610 of FIG. 6. As shown in a display 620, a window 621 can list various annotation files available for overlay. The annotation files can be listed by file name, by user, by data, or by any other sorting method. In one implementation, a GET ANNOTATIONS button can be selected to activate an annotations search process. The annotations can be from one or more sources. Once selected, the annotation data is rendered and displayed. For example, one file may include highlighted selections of text 631 as shown in a display 630. Using a toolbar 611 with various annotation tools, a user can add additional annotations and save as a new file, or append to the existing annotations. In another example, a user can originate all annotations and create a new file to save the annotation data.

In another embodiment, annotations can be listed on document load automatically from the remote server or Internet and can be read-only or non-editable.

In still another embodiment, annotations can play a role of redactions in which the author of a document creates an annotation to block certain portions of document to be non-readable in the viewer by other users.

In other embodiments, display of annotation files can be varied. For example, a viewer can be divided into frames, a top frame containing an annotation toolbar, a side frame containing annotation files, and a main frame displaying a remote file and annotations.

In FIG. 4B, a method for annotation a local file is detailed. In contrast to method 400 of FIG. 4A, a local file is accessed and displayed with available annotations. Similar to method 400, the annotations are stored separately from the local file, such as on a server or on the Internet.

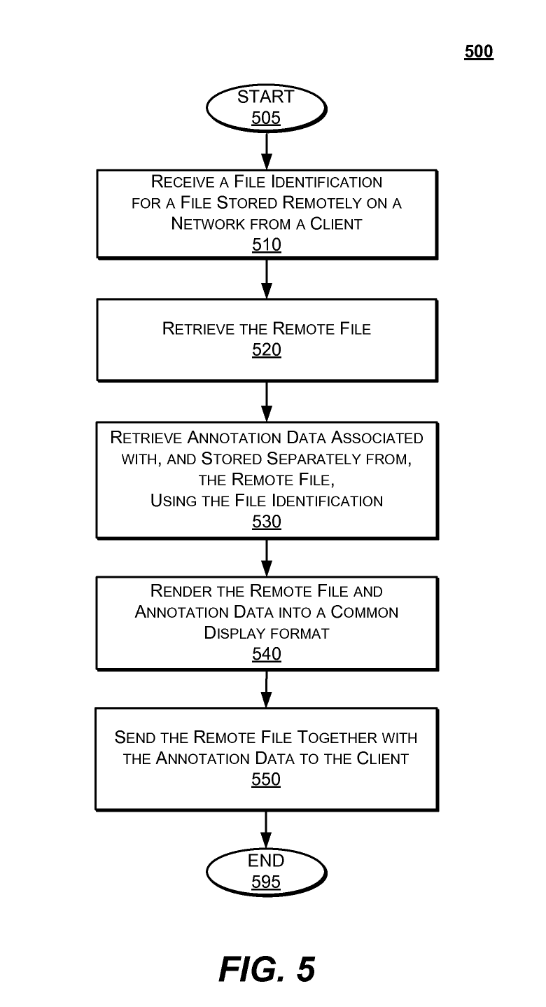

FIG. 5 is a flow chart illustrating a method 500 for annotation of remote resources with remote rendering, according to one embodiment of the present invention. In contrast to the method 400 of FIG. 4, the method 500 performs server-side rendering to allow a thinner client for implementations such as a mobile phone or PDA.

A file identification for a remote file is received 510 from a client (by e.g., the annotation server 102). In one embodiment, an annotation server is configured as a proxy server to intercept all URL requests from a client. The remote file is retrieved 520 by an annotation server first, rather than being sent back to the client. Any associated annotation data is retrieved 530 using a file identifier.

The combined remote file and annotation data is rendered by an annotation server, using a common format. Then the rendered remote file and annotation data is sent 550 to a client. In one embodiment, a web browser includes JavaScript or Flash code to display the remote file.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer-implemented method for viewing file annotations, the method comprising:
accessing a file;
retrieving annotation data associated with the file, the annotation data stored separately from the file, the annotation data including changes from at least one user about the file; and
displaying the file together with the changes.

2. The method of claim 1, further comprising:
receiving additional annotations to the file being displayed; and
storing the additional annotations with the annotation data, separately from the file.

3. The method of claim 1, further comprising:
converting the file from a first native format from a plurality of native formats to a display format.

4. The method of claim 1, wherein displaying the annotation data comprises:
displaying the annotation data from a plurality of users, including the at least one user, as a list of annotations.

5. The method of claim 1, wherein retrieving the annotation data comprises:
sending a file identification for the file to an annotation server, the annotation server matching the file
identification against a database table including file identifications; and
receiving the annotation data.

6. The method of claim 1, wherein displaying the annotation data comprises:
displaying the annotation data as an overlay to the file.

7. The method of claim 1, wherein the at least one user is from a plurality of users connected in a social network.

8. The method of claim 1, wherein the annotation data is limited to changes from authorized users.

9. The method of claim 1, further comprising:
requesting, from a client, the file from an annotation server which stores the annotation data and relays the request for the file to a web server, the annotation server receiving the file and overlaying the annotation data over the file, prior to sending to the client.

10. The method of claim 1, wherein the annotation data is loaded automatically from when the file is displayed viewer.

11. The method of claim 1 wherein the changes are read-only or non-editable by the user.

12. The method of claim 1, wherein the file is stored remotely.

13. A computer-implemented method for viewing file annotations, the method comprising:
receiving a file stored remotely on a network in a web server, the web server controlled by a first entity;
retrieving annotation data associated with the remote file using a file identification, the annotation data stored separately from the remote file in an annotation server, the annotation server controlled by a second entity independent from the first entity, the annotation data including changes from at least one user about the remote file;
converting the remote file from a first native format to a common display format, the common display format used to display remote files of a plurality of native formats;
rendering the remote file in the common display format with the annotation data; and
displaying the remote file with the changes.

14. A client to view file annotations, the client comprising:
an annotation viewer to access a file;
a communications module, coupled in communication with the annotation viewer, the communications module to retrieve annotation data associated with the file using an identifier, the annotation data stored separately from the file, the annotation data including changes from at least one user about the file; and
a local annotation processing engine, coupled in communication with the communications module, the local annotation processing engine to render a combination of the file and the annotation data,
where in the annotation viewer displays the file together with the changes.

15. An annotation server, the annotation server comprising:
a communications module to receive a file stored remotely on a network, responsive to receiving an identifier of the remote file from a client;
an annotation database, coupled in communication with the communications module, the annotation database to retrieve annotation data associated with the remote file, the annotation data stored separately from the remote file, the annotation data including changes from at least one user to the remote file; and
a remote annotation processing engine, coupled in communication with the annotation database, the remote annotation processing engine to render a combination of the remote file and the annotation data,
wherein the communications module sends the rendered combination to the client.
